(19) United States
(12) Patent Application Publication
(10) Pub. No.: US 2019/0285000 A1
(43) Pub. Date: Sep. 19, 2019

(54) PROPULSION SYSTEM OF AN AIRCRAFT COMPRISING A DUAL-FLOW JET ENGINE AND AN AIR-DRAWING SYSTEM WITH REDUCED BULK

(71) Applicant: Airbus Operations SAS, Toulouse (FR)

(72) Inventors: Jean GELIOT, TOULOUSE (FR); Adeline SOULIE, VERDUN SUR GARONNE (FR)

(21) Appl. No.: 16/271,300

(22) Filed: Feb. 8, 2019

(30) Foreign Application Priority Data
Mar. 13, 2018 (FR) 1852135

(51) Int. Cl. F02C 7/18; F02K 3/02; B64D 33/08; B64D 27/18

(52) U.S. Cl. CPC F02C 7/18; F02K 3/025; F05D 2260/213; B64D 27/18; B64D 33/08

(57) ABSTRACT

A propulsion system for an aircraft comprising an air system, the propulsion system comprising a fairing having an openwork grating, a dual-flow jet engine with a compression stage and a secondary jet, and an air-drawing system comprising a heat exchanger. A hot pipeline connects between the compression stage and the air system, and passing through the heat exchanger. A cold pipeline connects between the secondary jet and the openwork grating and passes through the heat exchanger. The air-drawing system comprises a shutter arranged at the openwork grating and displaced by a motor between an open position in which the shutter does not block the holes of the openwork grating and a closed position in which the shutter blocks the openwork grating holes. The incorporation of the discharge and regulation function at the openwork grating allows for a space saving facilitating incorporation of the air-drawing system in the propulsion system.

### CROSS-REFERENCES TO RELATED APPLICATIONS

This application claims the benefit of the French patent application No. 1852135 filed on Mar. 13, 2018, the entire disclosures of which are incorporated herein by way of reference.

### FIELD OF THE INVENTION

The present invention relates to a propulsion system for an aircraft comprising a dual-flow jet engine and an air-drawing system with reduced bulk. The present invention relates also to an aircraft comprising at least one such propulsion system.

### BACKGROUND OF THE INVENTION

FIG. 5 shows a diagram representative of an air-drawing system 500 of an aircraft according to the state of the art. Such a drawing system 500 is installed in a pylon under which is attached a dual-flow jet engine.

The dual-flow jet engine conventionally comprises an engine core supplied with air by a fan and comprising a compression stage, a combustion stage and an exhaust stage.

The air-drawing system 500 draws hot air from the dual-flow jet engine at the compression stage 504 and delivers it to an air system 506, such as, for example, the conditioned-air system of the cabin of the aircraft.

To regulate the temperature of the hot air thus delivered to the air system 506, the air from the compression stage 504 passes through a heat exchanger 508 which is supplied also with cold air drawn from the secondary jet 510 of the dual-flow jet engine.

After having passed through the heat exchanger 508 and having picked up calories from the hot air, the cold air which has thus been reheated is discharged outwards through an openwork grating 512 arranged on the surface of the pylon.

The flow of cold air from the secondary jet 510 is regulated by a valve 514 which is controlled by a motor 516 which controls the opening or the closing of the valve 514 according to the temperature requirements of the air system 506.

Although such an installation gives good results, it is relatively bulky, in particular because the dual-flow jet engines have increasingly great diameters. Indeed, because of this dimensional increase, the dual-flow jet engine is fixed as close as possible to the air foil, which reduces the space available for the drawing system.

### SUMMARY OF THE INVENTION

One object of the present invention is to propose a propulsion system for an aircraft comprising a dual-flow jet engine and an air-drawing system with reduced bulk.

To this end, there is proposed a propulsion system for an aircraft comprising an air system, said propulsion system comprising:
a fairing having an openwork grating,
a dual-flow jet engine with a compression stage and a secondary jet, and
an air-drawing system comprising:
a heat exchanger,
a hot pipeline fluidically connected between the compression stage and the air system, and passing through the heat exchanger,
a cold pipeline fluidically connected between the secondary jet and the openwork grating, and passing through the heat exchanger,

the propulsion system being characterized in that the air-drawing system comprises a shutter which is arranged at the openwork grating and which is displaced by a motor between an open position in which the shutter does not block the holes of the openwork grating and a closed position in which the shutter blocks the holes of the openwork grating.

The shutter makes it possible, depending on whether it is open or closed, to regulate the flow of cool air entering into the heat exchanger and allows for a space saving.

Advantageously, the shutter is mounted to be translationally mobile against the openwork grating on the interior side of said openwork grating.

Advantageously, the motor is arranged outside the cold pipeline, the propulsion system comprises a rod which transmits the movements of the motor to the shutter and the propulsion system comprises a sealing system installed at the point where the rod passes through the wall of the cold pipeline.

The invention also proposes an aircraft comprising an air system and at least one propulsion system according to one of the preceding variants.

### BRIEF DESCRIPTION OF THE DRAWINGS

The features of the invention mentioned above, and others, will become more clearly apparent on reading the following description of an exemplary embodiment, the description being given in relation to the attached drawings, in which:

FIG. 1 is a side view of an aircraft having at least one propulsion system according to the invention,

FIG. 2 is a schematic representation of an air-drawing system according to the invention,

FIG. 3 is a cross-sectional view of a detail of the air-drawing system in open position,

FIG. 4 is a view similar to that of FIG. 3, in closed position, and

FIG. 5 is a schematic representation of an air-drawing system of the state of the art.

### DETAILED DESCRIPTION OF THE PREFERRED EMBODIMENTS

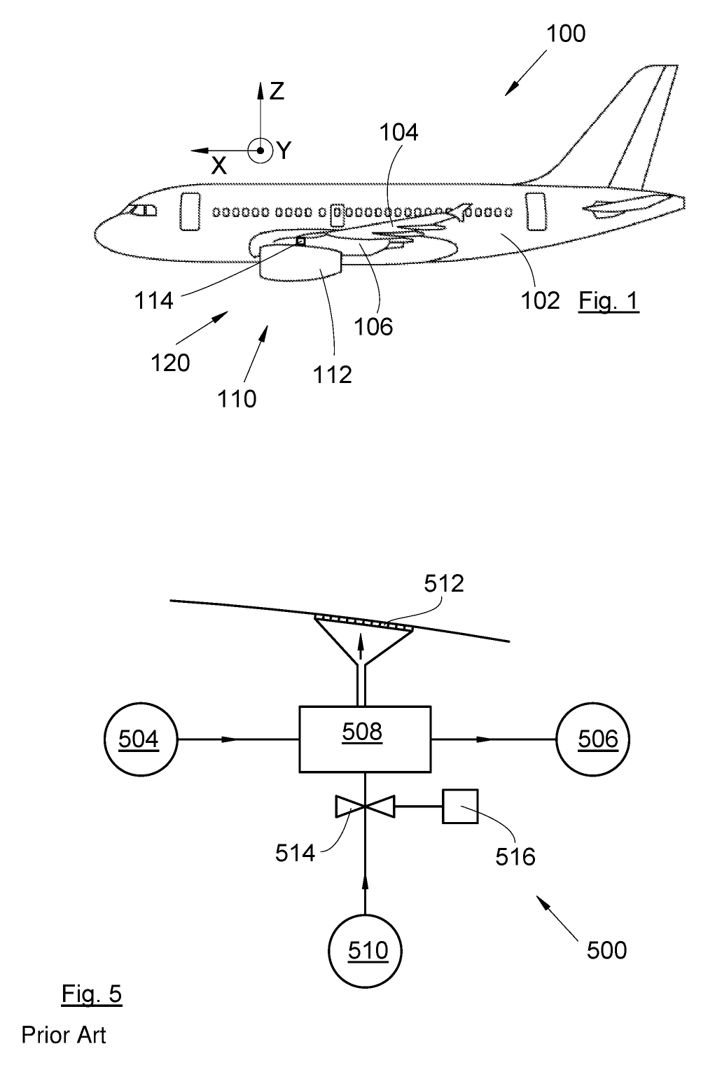

In the following description, the terms relating to a position are taken with reference to an aircraft in normal position of advance, that is to say as is represented in FIG. 1.

FIG. 1 shows an aircraft 100 which comprises a fuselage 102 having a wing 104 on each side and at least one propulsion system 120 comprising a dual-flow jet engine 110 and a pylon 106. The dual-flow jet engine 110 is surrounded by a nacelle and is fixed under each wing 104 via the pylon 106.

Throughout the following description, by convention, the direction X corresponds to the longitudinal direction of the dual-flow jet engine 110, this direction being parallel to the longitudinal axis of the aircraft 100. Also, the direction Y corresponds to the direction oriented transversely relative to the dual-flow jet engine 110, and the direction Z corresponds to the vertical direction or to the height, these three directions X, Y, Z being mutually orthogonal.

The propulsion system 120 comprises a fairing 112 which constitutes the outer skin of the dual-flow jet engine 110 and of the pylon 106 and which has an openwork grating 114 having holes that are here in the form of slits. In the embodiment of the invention presented in FIG. 1, the openwork grating 114 is on the pylon but, according to another embodiment, the openwork grating can be on the nacelle.

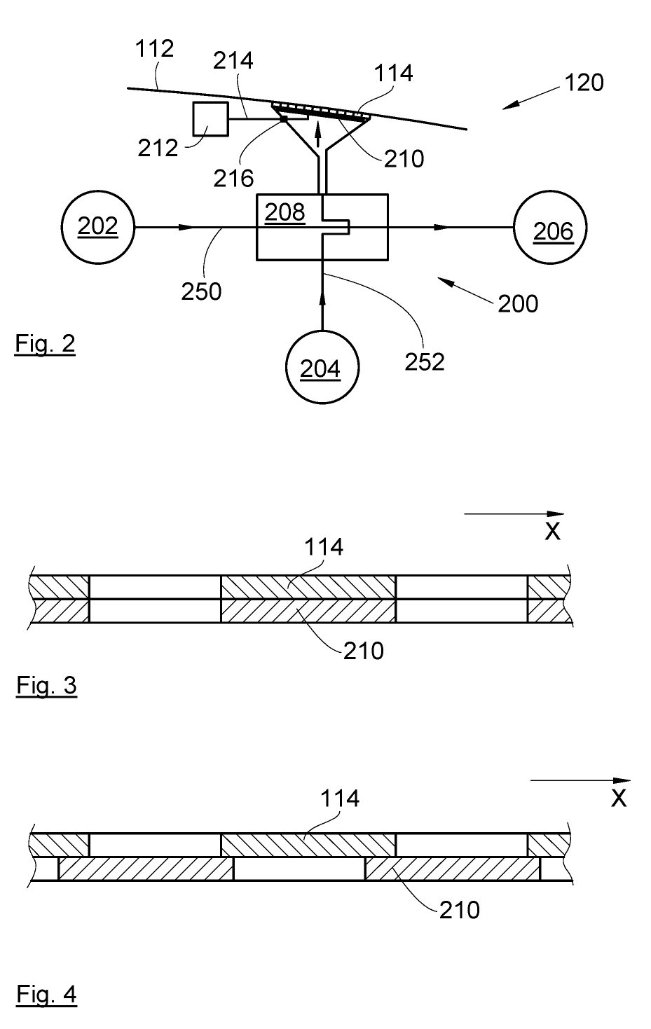

The dual-flow jet engine 110 comprises an engine core supplied with air by a fan and comprising a compression stage 202 (FIG. 2), a combustion stage and an exhaust stage. The dual-flow jet engine 110 also comprises a secondary jet 204 (FIG. 2) supplied with air by the fan and arranged around the engine core.

FIG. 2 shows a diagram representative of an air-drawing system 200 according to the invention and placed in the propulsion system 120 of the aircraft 100.

The air-drawing system 200 draws hot air from the dual-flow jet engine 110 at the compression stage 202 and delivers it to an air system 206, such as, for example, the conditioned-air system of the cabin of the aircraft 100.

To regulate the temperature of the hot air thus delivered to the air system 206, the air-drawing system 200 comprises a heat exchanger 208 which is thus supplied with hot air from the compression stage 202 and with cold air drawn from the secondary jet 204 of the dual-flow jet engine 110.

After having passed through the heat exchanger 208 and having picked up calories from the hot air, the cold air which has thus been reheated is discharged to the outside through the openwork grating 114.

Thus, the air-drawing system 200 comprises a hot pipeline 250 fluidically connected between the compression stage 202 and the air system 206, and passing through the heat exchanger 208, and a cold pipeline 252 fluidically connected between the secondary jet 204 and the openwork grating 114 and passing through the heat exchanger 208. The heat exchange which takes place in the heat exchanger 208 is effected between the cold air present in the cold pipeline 252 and the hot air present in the hot pipeline 250. The cold pipeline 252 widens at the openwork grating 114 in order to encompass all of the openwork grating 114.

To regulate the flow of cold air from the secondary jet 204, the air-drawing system 200 comprises a shutter 210 which is arranged at the openwork grating 114. The shutter 210 is mobile between an open position in which the shutter 210 does not block the holes of the openwork grating 114 and a closed position in which the shutter 210 blocks the holes of the openwork grating 114. Thus, in open position, the air from the heat exchanger 208 passes through the openwork grating 114 and, in closed position, the air from the heat exchanger 208 does not pass through the openwork grating 114.

The position of the shutter 210 is controlled by a motor 212 which displaces the shutter 210 from the open position to the closed position and vice versa and can make it take different intermediate positions between these two extreme positions. The motor 212 is controlled by a control unit of the aircraft 100 according to the temperature requirements of the air system 206.

When the shutter 210 is in open position, the air from the secondary jet 204 can be discharged through the holes of the openwork grating 114, and there is then creation of an air flow from the secondary jet 204 to the openwork grating 114 through the heat exchanger 208 by virtue of the pressure difference between the outside pressure and the pressure in the secondary jet 204.

Conversely, when the shutter 210 is in closed position, the air from the secondary jet 204 has no opening to be discharged, and there is therefore no flow of air in the heat exchanger 208.

The incorporation of the discharge and regulation function at the openwork grating 114 allows for a space saving, which facilitates the incorporation of the air-drawing system 200 in the propulsion system 120. In particular, it is possible to distance the heat exchanger 208 from the wing 104, which limits the impact of the air from the openwork grating 114 on the wing 104, and access to the air-drawing system 200 is facilitated since it is accessible directly by the removal of the cover forming the openwork grating 114.

FIG. 3 shows the shutter 210 in open position and not blocking the holes of the openwork grating 114 and FIG. 4 shows the shutter 210 in closed position and blocking the holes of the openwork grating 114.

According to the embodiment of the invention presented here, the shutter 210 is mounted to be translationally mobile between the open position and the closed position, in a direction parallel to the longitudinal axis x. The translation of the shutter 210 is produced by any appropriate guideway systems.

To limit the impact of the shutter 210, the latter is arranged on the interior side of said openwork grating 114.

Obviously, it is possible to provide a different displacement of the shutter 210 such as, for example, a rotational or translational displacement in a different direction.

In the embodiment of the invention presented in FIG. 2, the motor 212 is linked to the shutter 210 by a rod 214 which transmits the movements of the motor 212 to the shutter 210. Here, the motor 212 is arranged outside the cold pipeline 252, and to avoid leaks of air from the heat exchanger 208 to the adjacent zones, a sealing system 216, for example bellows-based, is installed at the point where the rod 214 passes through the wall of the cold pipeline 252 in order to guarantee the seal around the rod 214.

If the motor 212 is arranged inside the cold pipeline 252, in particular at the point where it widens in the vicinity of the openwork grating 114, it is not necessary to provide for the rod to pass through the wall of the cold pipeline 252, or a sealing system.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A propulsion system for an aircraft comprising an air system, the propulsion system comprising:
a fairing having an openwork grating,
a dual-flow jet engine with a compression stage and a secondary jet, and
an air-drawing system comprising:
a heat exchanger,
a hot pipeline fluidically connected between the compression stage and the air system, and passing through the heat exchanger,
a cold pipeline fluidically connected between the secondary jet and the openwork grating, and passing through the heat exchanger,
a shutter arranged at the openwork grating and being displaced by a motor between an open position in which the shutter does not block holes of the openwork grating and a closed position in which the shutter blocks the holes of the openwork grating.

2. The propulsion system according to claim 1, wherein the shutter is mounted to be translationally mobile against the openwork grating on an interior side of the openwork grating.

3. The propulsion system according to claim 2, wherein the motor is arranged outside the cold pipeline, wherein the propulsion system comprises a rod which transmits movements of the motor to the shutter and wherein the propulsion system comprises a sealing system installed at a point where the rod passes through a wall of the cold pipeline.

4. An aircraft comprising an air system and at least one propulsion system according to claim 1.
